(19) United States
(12) Patent Application Publication
(10) Pub. No.: US 2026/0233546 A1
(43) Pub. Date: Aug. 13, 2026

(54) JACKET FOR A COVER AND METHOD FOR APPLYING IT

(71) Applicant: PELEMAN INDUSTRIES NV, Puurs (BE)

(72) Inventor: Guido Frans M. Peleman, Knokke-Heist (BE)

(73) Assignee: PELEMAN INDUSTRIES NV, Puurs (BE)

(21) Appl. No.: 19/155,470

(22) PCT Filed: Feb. 2, 2024
(86) PCT No.: PCT/IB2024/050972

§ 371 Date: Aug. 11, 2025

(30) Foreign Application Priority Data
Feb. 16, 2023 (BE) 2023/5113

(51) Int. Cl. B42C 15/00; B42D 3/00; B42D 3/04

(52) U.S. Cl. CPC B42C 15/00; B42D 3/002; B42D 3/045

(57) ABSTRACT

A jacket for a cover of a book, the jacket includes a sheet that is divided into a central zone which covers the spine of the cover, two outer panel zones which each at least partially cover the exterior surface of the front panel and the back panel of the cover respectively and each including of two or more strips which extend from the bottom to the top of the cover, on the interior surface of the sheet only the outer panel zones are provided with a layer of self-adhesive material which in every strip of every outer panel zone is covered by a separate piece of removable release paper, and the strip of the two or more strips of every outer panel zone bordering the central zone is narrower than the sum of the widths of the other strips of the two or more strips.

### CROSS-REFERENCE TO RELATED APPLICATIONS

The present application is the National Phase entry of International Patent Application No. PCT/IB2024/050972 filed Feb. 2, 2024, which claims priority to Belgium Patent Application No. 2023/5113 filed Feb. 16, 2023, the entire contents of both are hereby incorporated by reference into this application.

### TECHNICAL FIELD

The present disclosure relates to a jacket for the cover of a book. More specifically the present disclosure relates to protecting a book with a hard cover.

### BACKGROUND

Traditionally, books are substantially made in two forms i.e. with a soft or a hard cover. Typically, books with a soft cover have a flexible cover of laminated paper or thin cardboard. Typically, books with a hard cover have a rigid cover of cardboard around which covering material, such as e.g. paper, is applied and which may or may not be provided with a laminate.

It is known to provide a jacket with printed paper for a book with a hard cover. Such known jacket is loosely folded around the hard cover of the book such that the jacket completely covers the exterior surface of the hard cover and is provided with flaps folded inwardly against the interior surface of respectively the front panel and the back panel of the hard cover. Usually, information relating to the content and/or the author is printed on the flaps. Such printed loose paper jackets are easy to apply and remove but are difficult to keep in the ideal position and also get damaged easily such that said jackets have more of a temporary function in the adequate protection of the cover.

A solution may include permanently affixing the jacket to the hard cover such that said jacket can no longer shift and thus partially expose the cover to the environment leaving it unprotected. However, such affixation may hinder the book to properly fold open, for example for reading. Furthermore, it is a challenge to correctly position the jacket relative to the cover for an adequate affixation.

GB 1480954 discloses a cover for a paperback provided with front and back cover panels which are both hingedly connected to an intermediate spine on a longitudinal side. The section of the inside of the front and back cover panel that will cover the exterior surface of the paperback is provided at its free edges (upper edge, lower edge and outer side edge) with double sided adhesive tape with removable release paper.

US 2008/0054619 A1 and US 2009/0179414 A1 disclose a jacket for a book. The jacket is provided with flaps which in use are folded such that the interior surface of the cover of the book is partially covered. An adhesive material is provided on the flaps. US 2009/0179414 A1 also provides adhesive material on the portion of the jacket that makes contact with the spine of the book.

### SUMMARY

It is an objective of the present disclosure to provide a solution that offers long-term protection to the cover.

It is also an objective of the present disclosure to provide a solution whereby the jacket is affixed to the cover such that properly folding open the book, for example for reading, is not hindered.

It is a further objective of the present disclosure to provide a solution which allows the jacket to be correctly positioned relative to the cover without or practically without the use of tools. Indeed, such tools need to be purchased which means an extra investment and moreover can be lost.

To at least partially meet one or several of the aforementioned objectives, the present disclosure, in one aspect, relates to a jacket for a cover of a book which is configured such that in use the jacket covers the exterior surface of the cover. The jacket comprises a sheet, the interior surface of which is divided into zones, comprising a central zone which in use covers the spine of the cover, and two outer panel zones which in use each at least partially cover the exterior surface of the front panel and the back panel of the cover respectively and each include two or more strips which in use extend from the bottom to the top of the cover, whereby on the interior surface of the sheet only the outer panel zones are provided with a layer of self-adhesive material which in every strip of every outer panel zone is covered by a separate piece of removable release paper. In embodiments, the strips of an outer panel zone are adjacent.

The strip of every outer panel zone adjacent to the central zone is also referred to as border strip such that, in other words, every outer panel zone includes a border strip and one or several additional strips that are each covered by a layer of self-adhesive material on each of which a separate piece of removable release paper is applied, such as for example paper with a silicone layer. The border strip of an outer panel zone is narrower than the sum of the widths of the other strips of said outer panel zone.

This solution allows the jacket, of which first the release paper of one or both border strips is removed to be positioned perfectly around the cover and subsequently be frozen in said position by pressing the jacket against the cover where the release paper is removed and as such partially affixing the jacket to the cover. Subsequently the remaining release papers can be removed and the jacket can be pressed further onto the sections provided with a self-adhesive layer, for example a double-sided adhesive layer or a hotmelt adhesive. In embodiments, this is done progressively starting from the central zone of the jacket moving toward the exterior surface. The aspect of this solution is that the jacket can be accurately affixed around the cover without tools.

In an embodiment according to the present disclosure at the front of the cover the jacket protrudes beyond the front panel and the back panel of the cover, whereby the protruding parts are folded inwardly to at least partially cover the interior surface of the front panel and the back panel, respectively. Thus, the zones on the interior surface of the jacket comprise two inner panel zones, i.e. the zones which in use each at least partially cover the interior surface of the front panel and the back panel of the cover, respectively. The inner panel zones can each be provided with a layer of self-adhesive material which is covered by a separate piece of removable release paper.

The jacket sheet is made of a flexible material such as for example paper, cardboard, or synthetic material. The printed or non-printed exterior surface of the sheet can be covered by a laminate. The sheet may, for example, also include cardboard on which paper may or may not be glued on the exterior surface. The paper may also be synthetic paper.

In an embodiment the border strip of an outer panel zone has a width that is less than 25% of the width of the front panel of the cover. The best result is obtained with a border strip that has a width within the range of 1 cm to 5 cm.

In an embodiment each outer panel zone comprises three or more adjacent strips, the widths of which progressively increase toward the exterior surface relative to the central zone.

In a further embodiment, the width of the central zone is chosen such that in use the central zone covers the spine of the cover and partially overlaps the front panel and the back panel of the cover. Typically, the overlap of the central zone with the back panel and the front panel respectively has a width within the range of a few centimeters. This has the aspect that the book can be folded open properly for reading while the jacket remains reliably affixed to the cover and can thus fulfil its protective function to a maximum extent.

Another aspect of the present disclosure relates to a method for affixing the jacket according to one of the previously described embodiments or a random combination thereof on a cover. The method comprises the steps of:
a) removing the removable release paper of at least one of both border strips, whereby a border strip is the strip of the two or more strips of every outer panel zone located nearest to the central zone;
b) applying the jacket around the cover whereby if the cover protrudes beyond the front panel and back panel of the cover, the inner panel zones are folded inwardly and at least partially cover the interior surface of the front panel and the back panel of the cover, respectively;
c) pressing the jacket against the cover on the level of the at least one border strip of which the removable release paper is removed; and
d) removing the remaining removable release paper of the strips of the outer panel zones and pressing the jacket against the cover on the level of the strips of which the removable release paper is removed.

In an embodiment of the present disclosure in the aforementioned step a) of the method, the removable release paper is removed from both border strips. Thus, after executing b) and c) the jacket is already adhered to the front panel and back panel of the cover at the border strips such that the central zone is already permanently in the correct position. Subsequently, the release paper of the other strips can be systematically removed and the freed strip can be pressed increasingly further away from the spine until the front panel and back panel are finished. Finally, the release paper of the inner panel zones is removed and said inner panel zones are pressed against the interior surface of the front panel and the back panel of the cover.

### BRIEF DESCRIPTION OF THE DRAWINGS

With the intention of better showing the characteristics of the present disclosure, embodiments according to the present disclosure of a jacket for a cover, and of a method for affixing such jacket to a cover is described hereinafter by way of an example, without any limiting nature, with reference to the accompanying drawings, wherein:

FIG. 1A schematically shows a perspective view of an embodiment according to the present disclosure of a jacket for a cover;

FIG. 1B schematically shows a top view of the interior surface of the embodiment according to the present disclosure of the jacket for the cover;

FIG. 1C schematically shows a magnified longitudinal section view of the embodiment according to the present disclosure of the jacket for the cover;

FIG. 2 schematically shows an exploded view of the jacket shown in FIG. 1;

FIG. 3A schematically shows step A of an embodiment of the method according to the present disclosure;

FIG. 3B schematically shows step B of the embodiment of the method according to the present disclosure;

FIG. 3C schematically shows step C of the embodiment of the method according to the present disclosure;

FIG. 3D schematically shows step D of the embodiment of the method according to the present disclosure;

FIG. 3E schematically shows step E of the embodiment of the method according to the present disclosure;

FIG. 3F schematically shows step F of the embodiment of the method according to the present disclosure;

FIG. 3G schematically shows step G of the embodiment of the method according to the present disclosure;

FIG. 3H schematically shows step H of the embodiment of the method according to the present disclosure;

FIG. 3I schematically shows step I of the embodiment of the method according to the present disclosure;

FIG. 3J schematically shows step J of the embodiment of the method according to the present disclosure;

FIG. 3K schematically shows step K of the embodiment of the method according to the present disclosure;

FIG. 3L schematically shows step L of the embodiment of the method according to the present disclosure;

FIG. 3M schematically shows step M of the embodiment of the method according to the present disclosure;

FIG. 3N schematically shows step N of the embodiment of the method according to the present disclosure;

FIG. 3O schematically shows step O of the embodiment of the method according to the present disclosure; and

FIG. 3P schematically shows step P of the embodiment of the method according to the present disclosure.

### DETAILED DESCRIPTION

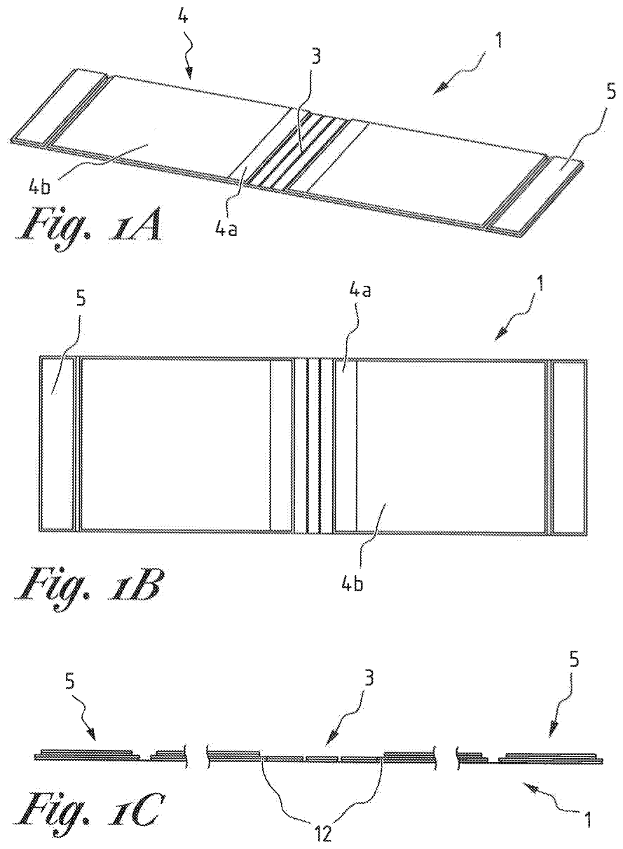

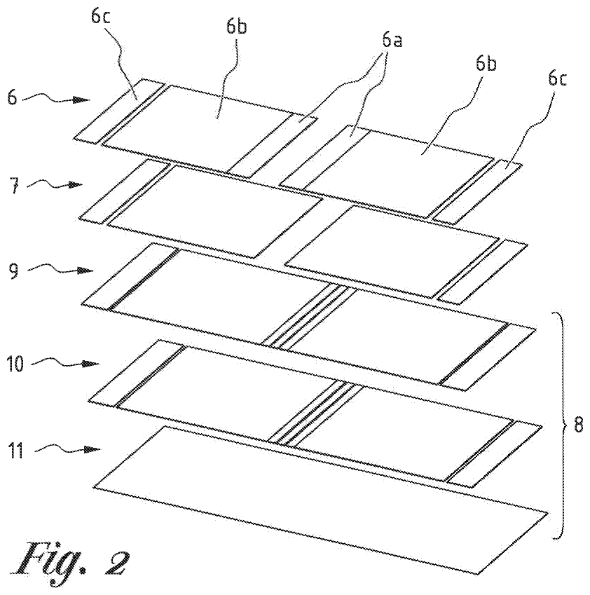

The jacket 1 as shown in FIG. 1 in different views and in FIG. 2 in exploded view comprises a sheet 8, the interior surface of which is divided into a number of zones. The interior surface of the sheet 8 is the side which in use, when the jacket 1 is folded around the cover 2, faces the cover 2. The central zone 3 is the zone which in use covers the spine of the cover 2 that is made up of a base and two protruding legs whereby the spine of the cover 2 in closed condition of the cover 2 substantially has a U-shaped cross-section.

Next to the central zone 3, on both sides an adjacent outer panel zone 4 is located. The outer panel zones 4 are the zones of the jacket 1 which in use partially cover the exterior surface of the front panel and the back panel of the cover 2 respectively.

In this shown embodiment the central zone 3 in use not only covers the spine of the cover 2 but extends outwardly beyond the legs of the spine of the cover 2, overlapping the front panel and the back panel of the cover 2 respectively. The width of each of the formed overlaps is 1 to several centimetres.

The outer panel zones 4 of the jacket 1 each include parallel strips 4a, 4b which in use extend from the bottom to the top of the cover 2, i.e. a first narrow strip 4a, i.e. the border strip, is adjacent to the central zone 3 and in the example shown has a width of 2 cm to 3 cm, and adjacent thereto a second wide strip 4b. An inner panel zone 5 is located next to each of the outer panel zones 4. In use the inner panel zones 5 each partially cover the interior surface of the front panel and the back panel of the cover 2, respectively. The small space between the inner panel zone 5 and adjacent outer panel zone 4 facilitates folding the inner panel zone 5 of the jacket 1 inwardly.

The sheet 8 of the jacket 1 shown in the figures includes preformed flexible cardboard 9 on which paper or a synthetic paper 11, which may or may not be printed, is affixed on the exterior surface using an intermediate double-sided adhesive layer 10 which may or may not be interrupted where the cardboard 9 is also interrupted.

Synthetic paper is a material made from epoxy that is made to have properties that are similar to ordinary paper. Typically, synthetic paper is made from high-density biaxially oriented polypropylene or polyethylene.

On the interior surface of the sheet 8, a double-sided adhesive layer 7 is only applied in the inner panel zones 5 and the outer panel zones 4. In other words, no adhesive layer 7 is provided in the central zone 3. There is no adhesive layer either in the zone where the cardboard 9 is interrupted. The adhesive layer 7 is covered by a removable release paper 6 including paper provided with a silicone layer. Alternatively any other covering can be used that effectively protects the adhesive layer 7 and can be easily removed without damaging or deforming the adhesive layer 7. The release paper 6 includes separate pieces of release paper 6a, 6b, 6c for every inner panel zone 5 or strip 4a, 4b, more specifically a piece of release paper 6a covers the adhesive layer 7 in each of the border strips 4a, a piece of release paper 6b covers the adhesive layer 7 in each of the other strips 4b, and a piece of release paper 6c covers the adhesive layer 7 in each of the inner panel zones 5.

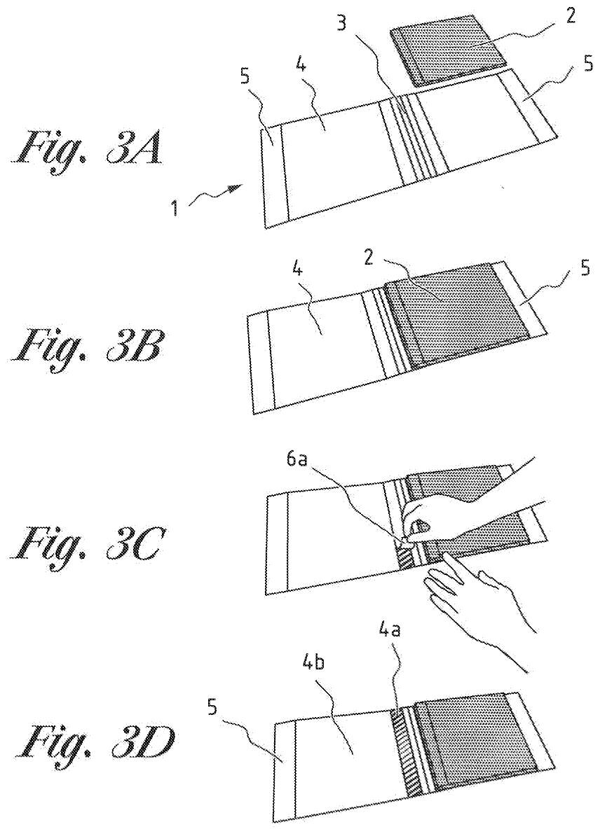

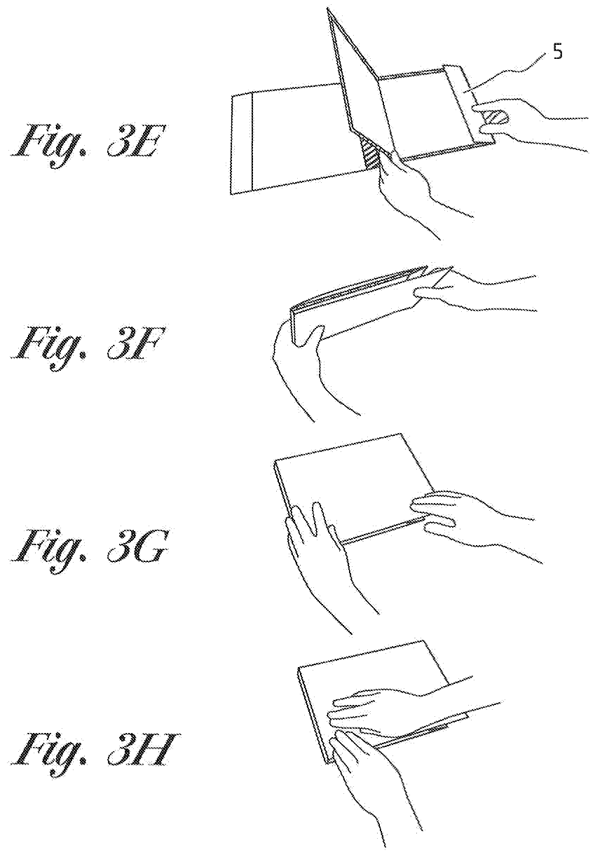

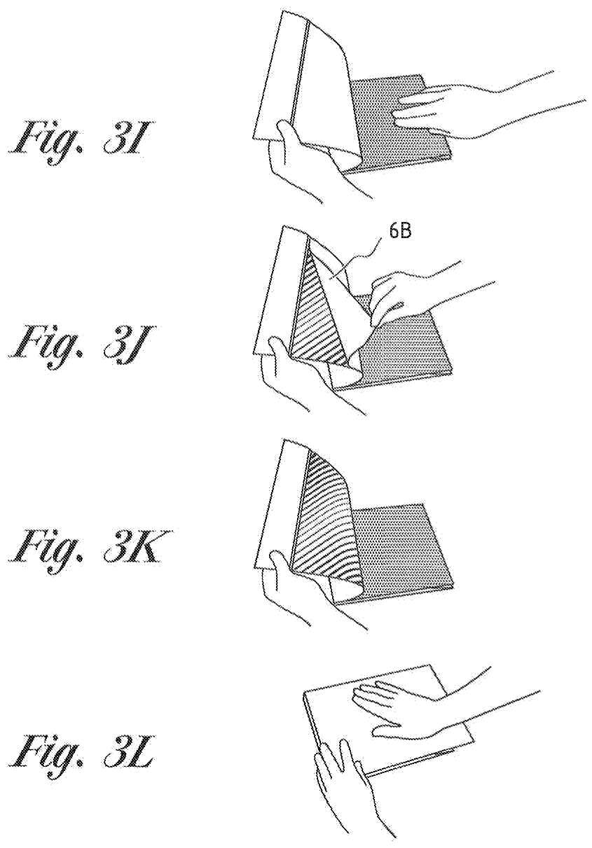

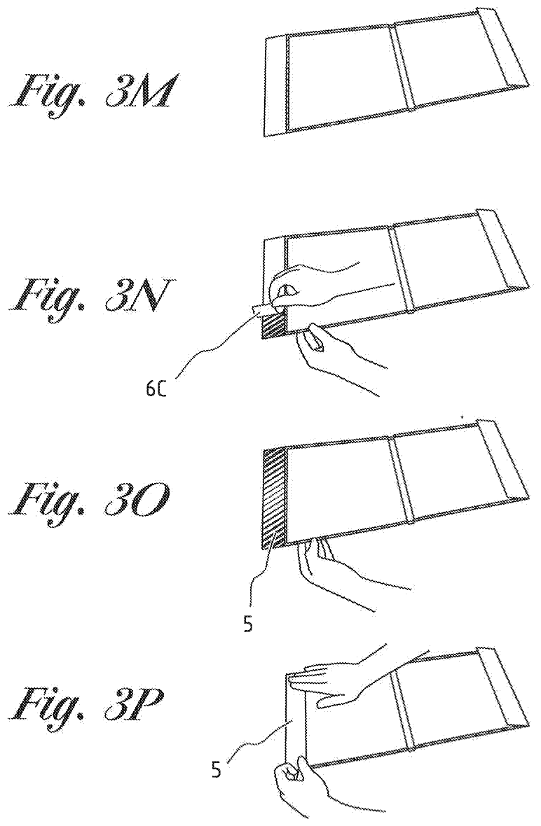

Affixing the jacket 1 to a cover 2 can be realised in a simple manner. With reference to the characteristics of the jacket 1 as shown in FIGS. 1 and 2, an embodiment of the method for affixing said jacket 1 substantially comprises the steps as shown in FIG. 3.

FIG. 3A shows the jacket 1 in open condition resting on its exterior surface, i.e. the side facing outwardly when the jacket 1 is folded around the cover 2, and the cover 2 in closed condition.

The cover 2 is placed in closed condition on the side of the jacket 1 which in use faces inwardly. This is done with the spine of the cover 2 facing the central zone 3 and with a panel, selected from one of the front panel and the back panel, overlapping the outer panel zone 4 of the jacket 1 corresponding with the selected panel. As an example, the selected panel is the back panel and that thus the cover 2, as shown in FIG. 3B, is placed with the back panel on the jacket 1.

The removable release paper 6 a, as shown in FIGS. 3c and 3D, is removed from the border strip 4a in use corresponding with the front panel of the cover 2.

The cover 2 is opened, as shown in FIG. 3E and first the flap of the jacket 1 with the inner panel zone 5 corresponding with the back panel is folded inwardly against the cover 2. Subsequently, the jacket 1 is also folded around the front panel of the cover 2 such that the cover 2 and the jacket 1 are aligned relative to each other as shown in FIG. 3F.

The cover 2 with the jacket 1 is closed resting on the back panel, as shown in FIG. 3G, and the border strip 4a, of which the release paper 6a is removed, is pressed against the front panel of the cover 2, as shown in FIG. 3H, such that the jacket 1 and the cover 2 are adheringly connected to each other by the adhesive layer and their relative position is frozen.

Subsequently the jacket 1 of the front panel is folded back, as shown in FIG. 3I, and the removable release paper 6b of the strip 4b adjacent to the adhesive border strip is removed, as shown in FIGS. 3J and 3K. The jacket 1 is folded back again around the cover 2, as shown in FIG. 3L, and strip 4b of which the release paper 6b is removed is pressed against the front panel of the cover 2. In this example the outer zones are each divided in one border strip and one additional strip. Alternatively, for example in case of large sizes, for applying several additional strips each provided with a separate release paper, the steps shown in FIGS. 3I to 3L can be repeated for each of those additional strips starting with the additional strip bordering the border strip and further progressively toward the exterior surface.

Subsequently, the cover 2 is opened again, as shown in FIG. 3M, and the removable release paper 6c of the inner panel zone 5 of the jacket 1 corresponding with the front panel of the cover 2 is removed, as shown in FIGS. 3N and 30. The flap of which in the inner panel zone 5 the release paper 6c is removed is pressed against the interior surface of the front panel of the cover 2, as shown in FIG. 3P. The corresponding inner panel and outer panel zones 4 of the jacket 1 are now adhered to the front panel. Analogously, the jacket 1 with the corresponding inner panel and outer panel zones 4 are now systematically applied against the back panel of the cover 2 starting with the border strip 4a, then the other strip 4b of the relevant outer panel zone 4, and finally the inner panel zone 5.

An alternative embodiment of the method for affixing the jacket 1 comprises the steps as described hereinafter with reference to the characteristics of the jacket 1 as shown in FIGS. 1 and 2.

The jacket 1 is placed on a table or another flat surface in open condition resting on its exterior surface, i.e. the side facing outward when the jacket 1 is folded around the cover 2. The removable release paper 6a is removed from the border strips 4a on both sides of the spine.

The cover 2 is placed upright on the table in open condition and the jacket 1 is folded around the cover 2 without exerting pressure on the cover 2 near the border strips 4a of which the release paper 6a is removed.

The jacket 1 is aligned relative to the cover 2 and the cover 2 with the jacket 1 is placed on the table in closed condition resting on the back panel or the front panel.

The border strip 4a of which the release paper 6a is removed is pressed against the upward facing panel of the cover such that the jacket 1 and the cover 2 are adheringly connected by the adhesive layer and their relative position is frozen. Subsequently, the cover 2 with the jacket 1 is turned over and the other border strip 4a of which the release paper 6a is removed is pressed against the upward facing panel of the cover 2.

Subsequently, the jacket 1 of the upward facing panel is turned back and the removable release paper 6b of the strip 4b adjacent to the adhesive border strip is removed. The jacket 1 is folded back again around the cover 2 and strip 4b of which the release paper 6b is removed, is pressed against the upward facing panel of the cover 2. Subsequently, the flap of the jacket 1 of the upward facing panel is turned back and the removable release paper 6c of the inner panel zone 5 of the jacket 1 corresponding with the upward facing panel of the cover 2 is removed. The flap, of which the release paper 6c is removed in the inner panel zone 5, is pressed against the interior surface of the upward facing panel of the cover 2. The corresponding inner panel and outer panel zones 4 of the jacket 1 are now adhered to the front panel.

The cover 2 with the jacket 1 is turned over and the procedure is repeated for the other strip 4b, and for the other inner panel zone 5.

The present disclosure is not limited to the embodiments described as an example and shown in the drawings, but a jacket for a cover and method for affixing such jacket to a cover can be realised in all kinds of forms and dimensions without departing from the scope of the present disclosure.

1. A jacket for a cover of a book configured such that in use the jacket covers an exterior surface of a front panel and a back panel of the cover, the jacket comprises:
a sheet, an interior surface of the sheet is divided into, a central zone which in use covers a spine of the cover, two outer panel zones which in use each at least partially cover the exterior surface of the front panel and the back panel of the cover respectively and each of the two outer panel zones includes two or more strips,
wherein on the interior surface of the sheet only the two outer panel zones are provided with a layer of self-adhesive material and in which each of the two or more strips of the two outer panel zones is covered by a separate piece of removable release paper,
wherein each of the two or more strips in use extends from a bottom to a top of the cover, and a strip of the two or more strips of each the two outer panel zones bordering the central zone is narrower than a sum of a widths of the other strips of the two or more strips.

2. The jacket according to claim 1, wherein the strip of the two or more strips of each of the two outer panel zones bordering the central zone has a width of several centimetres.

3. The jacket according to claim 1, wherein the strip of the two or more strips of each of the two outer panel zones bordering the central zone has a width that is less than 25% of a width of the front panel of the cover.

4. The jacket according to claim 1, wherein the two or more strips of each of the two outer panel zones are adjacent.

5. The jacket according to claim 1, wherein, each of the two outer panel zones comprises three or more adjacent strips of which widths progressively increase facing outwardly relative to the central zone.

6. The jacket according to claim 1, wherein a width of the central zone is chosen such that in use the central zone covers the spine of the cover and partially overlaps the front panel and the back panel of the cover.

7. The jacket according to claim 6, wherein the central zone overlaps the back panel and the front panel respectively over a width within a range of 1 centimetre to several centimetres.

8. The jacket according to claim 1, wherein the layer of self-adhesive material is a double-sided adhesive layer or a hotmelt adhesive.

9. The jacket according to claim 1, wherein the removable release paper is paper with a silicone layer.

10. The jacket according to claim 1, wherein the sheet of the jacket includes flexible cardboard or flexible cardboard on which synthetic paper is affixed on an exterior surface.

11. The jacket according to claim 1, wherein the jacket protrudes at a front of the cover beyond the front panel and the back panel of the cover, wherein protruding parts are folded inwardly to at least partially cover an interior surface of the front panel and the back panel respectively, and wherein the interior surface of the jacket comprise two inner panel zones which in use each at least partially cover the interior surface of the front panel and the back panel of the cover respectively.

12. The jacket according to claim 11, wherein the two inner panel zones are each provided with a layer of self-adhesive material which is covered by a separate piece of removable release paper.

13. A method for affixing the jacket the cover according to claim 1, the method comprising the steps of:
a) removing the removable release paper of at least one of both of border strips, the border strip is the strip of the two or more strips of each of the two outer panel zones located nearest to the central zone;
b) applying the jacket around the cover;
c) pressing the jacket against the cover on a level of the at least one border strip of which the removable release paper is removed; and
d) removing the remaining removable release paper of the strips of the two outer panel zones and pressing the jacket against the cover on the level of the strips of which the removable release paper is removed.

14. The method according to claim 13, wherein in step a) the removable release paper of both border strips is removed.
